(19) United States
(12) Patent Application Publication
(10) Pub. No.: US 2007/0201765 A1
(43) Pub. Date: Aug. 30, 2007

(54) Intelligent Digital Image Cropping System

(76) Inventor: Charles L. DuBois, Rochester, NY (US)

Correspondence Address: Dennis B. Danella, Esq.;JAECKLE FLEISCHMANN & MUGEL, LLP, 190 Linden Oaks, Rochester, NY, 14625-2812, US

(21) Appl. No.: 11/673,223

(22) Filed: Feb. 9, 2007

Related U.S. Application Data
(60) Provisional application No. 60/776,404, filed on Feb. 24, 2006.

(51) Int. Cl. G06K 9/32

(52) U.S. Cl. 382/293

(57) ABSTRACT

An image processing system allows a customer to upload a digital image in an initial frame size and indicate the desired finished print size. The system then searches for the presence and location of an area of interest in the digital image. Upon finding and determining the location of the area of interest, the system then calculates a crop border size and placement which preferentially positions the area of interest within the finished print.

### CROSS-REFERENCE TO RELATED APPLICATIONS

This application claims the benefit of U.S. Provisional Patent Application Ser. No. 60/776,404, filed Feb. 24, 2006.

### FIELD OF THE INVENTION

The present invention generally relates to digital image processing systems. More particularly, the present invention relates to an apparatus and method for automatically cropping a digital image based on the location of a detected area of interest such as a person's face or eyes, for example.

### BACKGROUND OF THE INVENTION

Digital photo image processing is a rapidly growing technology area. Photographic images may be uploaded as a digital file to a computer using a digital camera or a scanned image appearing on paper or photographic film, for example. The uploaded digital image may thereafter be further digitally processed as desired. Present day photo processing software allows extensive modifications to be made to a digital image to improve clarity and color balance, to remove unwanted matter (e.g., “red-eye”) and to change the digital frame size to any desired print size, for example. The image processing may be done by the user using image processing software on their personal computer or at a photo kiosk, or a customer may upload the digital image over the internet to be processed by a photofinishing service, for example. A photofinishing service can modify, print and mail (or otherwise make available) the desired prints or other product having the image thereon (e.g., mugs, blankets, CDs, etc.) to the user/customer. A user thus has many options as to how their digital images are ultimately converted to photographs or other image-bearing products (hereinafter collectively referred to as “prints”).

When a customer desires a print that is of a size different than the initial digital frame size, the initial digital frame size must be cropped (i.e., cut) to the desired print size to prevent image distortion. Cropping typically results in loss of at least some of the image, usually at one or more of the four rectangular border lengths of the initial digital image frame. For example, as seen in FIG. 1, a digital image having an initial frame size X₁, Y₁ is cropped by cropping lines 12A, 12B and 13A, 13B to a final print size X₂, Y₂. In this example, it is seen that part of both the top and bottom frame border lengths 10A and 10B, respectively, have been deleted, resulting in a loss of part of the original image. The resulting finished image print may or may not be acceptable to the user/customer, particularly if a part of the image considered significant to the customer is partly or wholly deleted by the cropping step. Unfortunately, present day digital image processing software that automatically crops an initial frame size to an ordered print size does so without regard as to whether or not there is a particular part of the image that the average customer would not want even partly deleted from the cropping operation. This may be a person's face 14A or eyes 14B in FIG. 1, for example, where, due to placement of the person's head in the original image frame 10, the upper cropping line 12A cuts off the top segment 14C of the person's head. The result is a finished print that would be unacceptable to the typical customer.

It would therefore be desirable from a customer satisfaction standpoint to be able to intelligently and automatically crop an initial digital image with regard to an area of interest in the image such that the area of interest is not cut and is preferentially placed in the finished print.

### SUMMARY OF THE INVENTION

The present invention successfully addresses the above need by providing an apparatus and method for an image processing system which automatically searches for and determines the location of an area of interest in a digital image prior to any cropping of the image. The area of interest can be a person's face and/or eyes, for example, although the invention is applicable to any type of area of interest that is machine-recognizable using present day or yet to be developed software apparatus and/or methods.

More particularly, the present invention provides a digital image processing apparatus and method wherein an uploaded digital image having an initial frame size is searched for the presence and location of an area of interest within the initial frame size. Software is presently available that can automatically detect a face and eyes within a digital image to correct the red-eye phenomenon common to flash photography.

Once the digital image has been uploaded, a user/customer selects a finished print size that may be different than the initial frame size. Based on the selected finished print size, the image processing software automatically determines a crop border size and placement with respect to the initial digital frame size with regard to the location of the previously detected area of interest. The size and placement of the crop border is such that the area of interest is preferentially positioned within the boundaries of the finished print. For example, the area of interest may be centered within the finished print, or positioned such that the entire area of interest is positioned on the finished print. It will of course be appreciated that if there is no area of interest detected during the search step, the system will execute a default crop setting for the particular initial frame size and print size selected.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawing, wherein:

FIG. 1 is a simplified block diagram of a prior art digital frame size and crop border;

FIG. 2 is a simplified block diagram showing an embodiment of the invention as applied to the digital image of FIG. 1;

FIG. 3 is a simplified block diagram showing an embodiment of the invention as applied to an image that is rotated 90° from the position seen in FIG. 2; and

FIG. 4 is a flow diagram showing basic process flow steps in an embodiment of the invention.

### DETAILED DESCRIPTION OF THE INVENTION

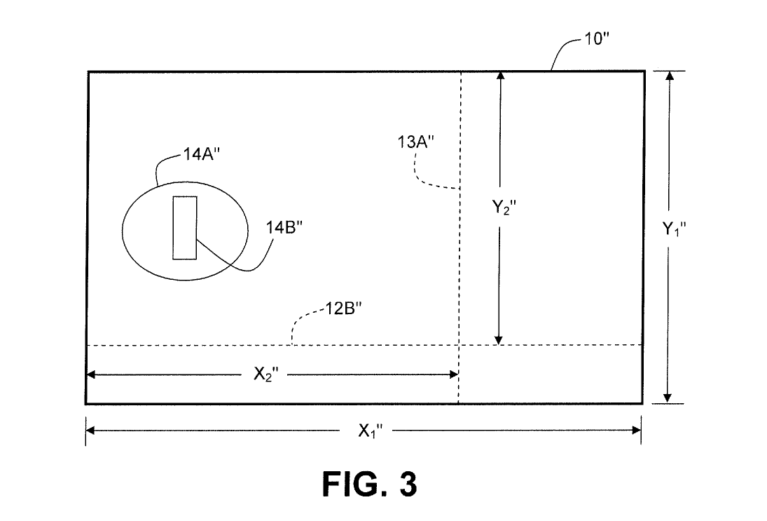

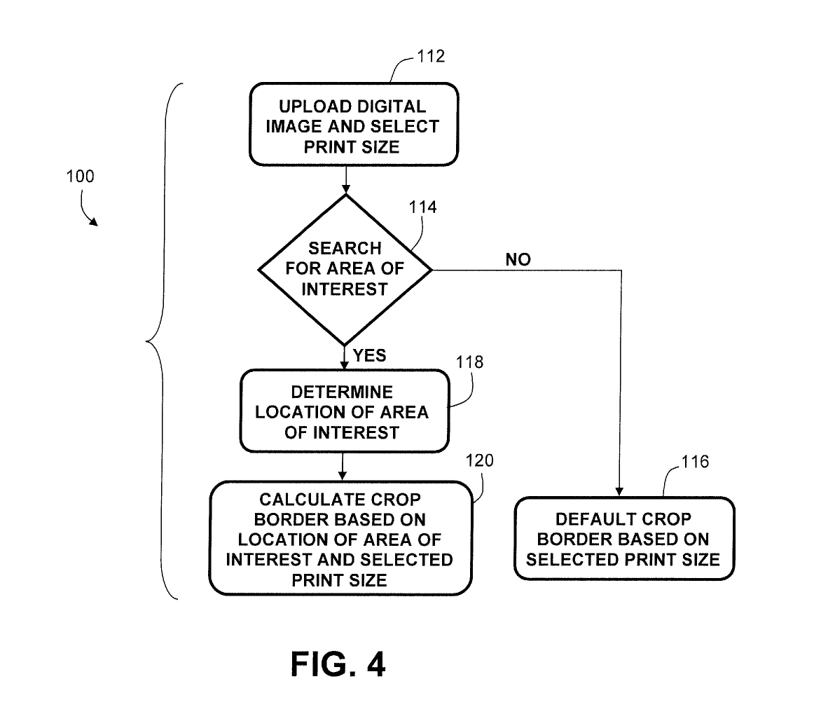

Referring to FIGS. 2-4, an embodiment of the present invention will now be described with regard to the basic process steps of a digital image processing system indicated generally by the reference numeral 100 in FIG. 4. System 100 may be embodied in a computer-readable medium or program having a set of computer-executable instructions for carrying out or performing the indicated digital image processing. The digital image processing of the present invention may be performed under the control of a user alone, a photofinishing service alone, or through communication and steps performed by both a customer and a photofinisher.

As illustrated in block diagram form in FIG. 4, system 100 allows a customer to upload one or more digital images to a personal computer or photofinisher as indicated at block 112. The digital images may be uploaded to a photofinisher in any desired manner such as using a wireless transmission directly from a digital camera, a personal computer, scanner, photo kiosk, or the like. In addition, it will be understood and appreciated that the photofinisher computer system may be in a location that is local or remote from the location in which the photo print orders are processed.

System 100 is configured such that the customer may upload one or more digital images and indicate the desired finished print size of each image at block 112. System 100 will then search each digital image for an area of interest at block 114. The area of interest which system 100 looks for may be of any desired type. For example, red-eye elimination software may search for and identify the location of a pair of eyes in a digital image. This same software may therefore be used in system 100 to search for and identify the location of a pair of eyes in a digital image. The area of interest in this embodiment is therefore a pair of eyes. It is understood, however, that the invention is not so limited, but rather is applicable to any desired area of interest that is machine-recognizable using presently known or yet to be developed software. Other possible areas of interest may be a mountain or the horizon in a landscape image, for example. It is also envisioned that there may be more than one area of interest within a single digital image. The software may include programming that considers and treats a plurality of areas of interest as a single (large) area of interest. Alternatively, the system may be programmed to rank each area of interest found according to its relative size or density distribution, for example. One possible technique for locating areas of interest in a digital image may be performed by dividing the digital image into a grid and determining the pixel saturation in the various squares of the grid. A weighting is assigned to the squares based on the pixel or luminosity saturation to determine areas of interest. Again, it is understood that the invention is applicable to any type and number of areas of interest in a digital image as well as any machine-recognizable method of determining the location of the area or areas of interest.

Referring still to FIG. 4, system 100 completes the search for an area of interest at block 114. If no area of interest was located during the searching step at block 114, system 100 will execute a default crop placement as indicated at block 116. The default crop placement is predetermined and programmed into system 100. The default crop placement may be a symmetrically centered crop border with respect to the initial frame size as is well known to those skilled in the art of designing digital image processing systems.

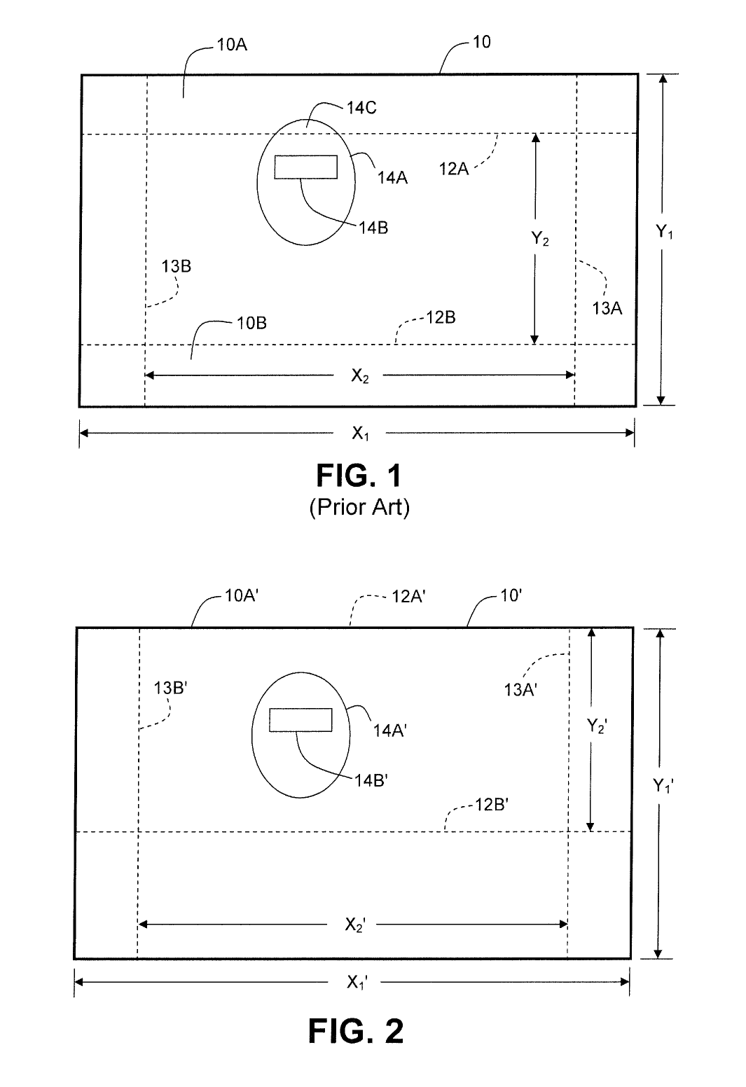

Conversely, should system 100 locate an area of interest at block 118, system 100 calculates a crop border size and placement with regard to the location of the area of interest and the requested print size at block 120. The size of the crop border is dictated by the requested finished print size. The placement of the crop border is dictated by the location of the area of interest. The placement of the crop border is such that the area of interest will be preferentially positioned within the finished print. For example, as seen in FIG. 2, system 100 locates an area of interest comprising a person's face 14A′ and/or a pair of eyes 14B′. The location of the area of interest is closest to the top border length 10A′ of the initial frame size 10′. If the prior art default crop border placement was used, the top of the person's head would be cut off by crop line 12A as seen in FIG. 1, which is an unacceptable outcome. Instead, system 100, knowing the location of the area of interest 14A′, 14B′, calculates the ideal placement of the crop border lines 12A′, 12B′ and 13A′, 13B′ which, in this example, is positioned at the highest location possible with respect to the initial frame size. It is thus seen that the crop border lower length 12B′ in FIG. 2 is positioned higher in the initial frame size 10′ than is the default crop border position 12B of FIG. 1. The crop border upper length 12A′ is likewise positioned higher and in this scenario is substantially coincident with upper frame length 10A′. System 100 thus calculates a crop border placement X2′, Y2′ wherein the area of interest (the person's head and/or eyes) is not cut off and is preferentially positioned entirely within the finished print and/or centered in the finished print which may be of any desired size such as 4×6, 5×7 or 8×10 inches, for example.

Referring to FIG. 3, a digital image may be uploaded 90° rotated from a typical “upright” image such as seen in FIG. 2. In this instance, system 100 locates the area of interest 14A″ and/or 14B″ as being to the far left of the initial frame size 10″. System 100 then calculates the border size and ideal placement X₂″, Y₂″ thereof with regard to the location of the area of interest. In this example, the crop border X₂″, Y₂″ is positioned to the far left so that the area of interest 14A′ and/or 14B′ is not cut off and is preferentially placed in the finished print.

It will be understood and appreciated that the method for digital image processing between a customer and a photofinisher described above may be accessible to and executed by system 100 in accordance with preprogrammed algorithms, execution instructions or sequences, computations, software code modules, interface specifications or the like. Further, the method performed by system 100 may be implemented in a computing environment such as a personal computer (PC) or other computing device. Such computer may also include a storage device including volatile and nonvolatile, removable and non-removable media implemented in any method or technology for storing information such as program modules, data structures, computer readable instructions, or other data.

The computer storage media may include, but is not limited to, floppy disks, conventional hard disks, read only memory (ROM), random access memory (RAM), flash memory, electrically erasable programmable read-only memory (EEPROM), or other types of memory, magnetic cassettes, magnetic tape, magnetic disk storage or other magnetic storage devices, CD-ROM, digital versatile disks (DVD) or other optical disk storage, or any other medium which can be used to store the desired information and which can be accessed by system 10, 110.

System 100 may also include communication media for sending and receiving signals, instructions or other parameters between the customer and the photofinisher. Communication media typically embodies computer readable instructions, data structures, program modules or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a direct wired connection, and wireless media such as acoustic, radio frequency, infrared and other wireless media. It will be understood that combinations of any of the above should also be included within the scope of computer readable media.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A computer-readable medium having computer-executable instructions for performing a method for automatically resizing a digital image from an initial frame size to a finished frame size, said digital image including an area of interest, said method comprising:
a) automatically detecting the position of said area of interest in said digital image;
b) calculating a preferential position of a crop border based on the detected position of said area of interest; and
c) cropping said initial frame size with said crop border at said preferential position resulting in said finished frame size.

2. A method in accordance with claim 1 wherein said area of interest is a face.

3. A method in accordance with claim 1 wherein said area of interest is a pair of eyes.

4. A method in accordance with claim 1 wherein the step of calculating the preferential position of said crop border includes positioning all of said area of interest within said finished frame size.

5. A method in accordance with claim 1 wherein the step of calculating the preferential position of said crop border includes centering said area of interest within said finished frame size.

6. A method for digital image communication between a customer and a photofinisher, said method comprising:
a) allowing the customer to upload a digital image having an initial frame size to a computer associated with the photofinisher;
b) allowing the customer to select a finished print size of said digital image;
c) determining the presence and location of an area of interest within said initial frame size;
d) calculating the preferential position of a crop border based on the detected position of said area of interest; and
e) cropping said initial frame size with said crop border at said preferential position resulting in said finished print size.

7. A method in accordance with claim 6 wherein the step of calculating the preferential position of said crop border includes positioning all of said area of interest within said finished print size.

8. A method in accordance with claim 6 wherein the step of calculating the preferential position of said crop border includes centering said area of interest in said finished print size.

9. A method in accordance with claim 6 wherein steps c) through e) are performed under the control of the photofinisher using a computer program having computer-executable instructions which are carried out automatically on said digital image upon receiving said finished print size from the customer.

10. A method in accordance with claim 9 further comprising the step of making available to the customer a finished print of said digital image in said finished print size.

11. A method in accordance with claim 9 wherein a finished print is shipped to the customer.

12. A method in accordance with claim 9 wherein a finished print is sent electronically to said customer.

13. A method in accordance with claim 9 wherein a finished print is made available for printing by the customer at a kiosk.

14. Apparatus for automatically resizing a digital image having an area of interest from an initial frame size to a finished frame size, said apparatus comprising a computer program configured for automatically detecting the presence and position of said area of interest in said digital image, and said computer program configured for calculating a preferential position of a crop border based on the detected position of said region of interest.

15. An apparatus in accordance with claim 14 wherein said computer program is configured for cropping said initial frame size with said crop border at said preferential position resulting in said finished frame size.
